(19) United States
(12) Patent Application Publication
(10) Pub. No.: US 2011/0084165 A1
(43) Pub. Date: Apr. 14, 2011

(54) DECOUPLING TECHNOLOGY OF THE STAIR HOUSE TO THE OVERHEAD COMPARTMENT

(75) Inventors: Jovan Ulbrich-Gasparevic, Pinneberg (DE); Thomas Sütthoff, Hamburg (DE)

(73) Assignee: AIRBUS OPERATIONS GMBH, Hamburg (DE)

(21) Appl. No.: 12/935,354

(22) PCT Filed: Feb. 19, 2009
(86) PCT No.: PCT/EP09/51987

§ 371 Date: Nov. 29, 2010

Related U.S. Application Data
(60) Provisional application No. 61/072,514, filed on Mar. 31, 2008.

(30) Foreign Application Priority Data
Mar. 31, 2008 (DE) 10 2008 016 418.6

(51) Int. Cl. B64D 11/00

(52) U.S. Cl. 244/118.6

(57) ABSTRACT

Aircraft that are used for intercontinental flights require individual compartments or rest areas (crew rest compartments) for pilots and flight attendants that are also referred to as room elements. It is known to arrange these room elements a certain distance above a seating area for the passengers, wherein these room elements can be reached from a floor structure via a room element in the form of a stair assembly (stairhouse). The room element is connected to the room element by means of locking elements in order to achieve an acoustic decoupling.

The present invention pertains to an aircraft with a fuselage, in which a resting and sleeping zone (overhead compartment) for the service or operating personnel, which is referred to as a room element and can be reached from a floor structure via a room element referred to as a stair assembly (stairhouse), is provided a certain distance above a seating area for the passengers.

According to legal regulations, aircraft that are used for intercontinental flights need to be equipped with individual compartments or rest areas for the pilots and for the flight attendants that also referred to as crew-rest, crew rest compartment or crew rest areas.

U.S. Pat. No. 4,066,227 A1 describes a so-called mezzanine construction on the main deck floor of the passenger compartment that can be used as a rest area for the flight attendants or the flight crew. The concept that incorporates a disadvantageous rigid connection between the floor structure and the fuselage of the aircraft disadvantageously reduces the passenger capacity. In an aircraft known from EP 1 279 593 B1, a room element for the flight personnel, which is realized in the form of a module, is provided in the overhead region of the passenger deck. This zone can be reached via a ladder that can be adjusted between an operative and a stowed position. This solution requires a complicated manipulation of the stairs and makes it more difficult to access the rest area.

In order to provide a rest area that offers sufficient comfort for the flight crew, as well as to prevent forces from being introduced into the structure of the room elements (overhead compartment, stairhouse), the invention aims to find other solutions.

It is an objective of the present invention to arrange a stair assembly (stairhouse) in such a way that it does not cause a disadvantageous noise development and is not subjected to any transmission of forces within the aircraft.

According to one exemplary embodiment of the present invention that is defined in claim 1, the room element in the form of a stairhouse features elastic locking elements, by means of which an acoustic decoupling from the other room element (overhead compartment) is realized. This decoupling technique between the room elements largely prevents the transmission of structure-borne noise and reduces the noise development. In this case, the acoustic decoupling is realized with consideration of optionally fixing the monuments relative to one another. According to another characteristic of the invention, the stair assembly (stairhouse) is on the one hand fixed on the floor structure by means of joints and the resting and sleeping zone (overhead compartment) is on the other hand fixed on the frame or fuselage structure of the aircraft by means of joints. Due to these measures, an optimal introduction of forces and distribution forces is realized in the aircraft structure, in which the suspended room element (overhead compartment) is assigned to the fuselage and the other, largely upright positioned room element (stairhouse) is assigned to the floor structure. This results in a structural design, in which the floor structure can always absorb the forces of a monument such as, for example, the galley, namely even if no module is in place. The upper frame structure of the aircraft therefore can be designed with consideration of the introduction of forces of the room element (overhead compartment), for example, with consideration of bunk modules (bunks). These measures cause an advantageous harmonic distribution of forces in the structure of all room elements (crew rest, crew rest compartment, stairhouse) and prevent a disadvantageous direct transmission of forces from the upper frame structure into the floor structure via the room elements. The inventive fixing of the room elements, as well as their acoustic decoupling, reduces the noise level in the passenger area of the aircraft to a level of 65 to 70 dB, i.e., a level that meets or lies below the required limit.

According to another advantageous exemplary embodiment of the present invention that is defined in claim 2, the locking element used in accordance with the invention allows a relative movement in the Z-direction and largely prevents relative movements in the X- and Y-directions. This characteristic of the locking element takes into account the requirement, according to which no direct transmission of forces from the frame structure into the floor structure of the aircraft should take place via the room elements (overhead compartment, stairhouse).

According to another advantageous exemplary embodiment of the present invention that is defined in claim 3, it is proposed to use a vibration-absorbing solid body or a spring element that respectively is functionally connected to a room element directly or indirectly as insulator for the locking element. Particularly suitable materials for the insulator are natural rubber elements made of caoutchouc, plastic elements that are preferably made of neoprene, spring elements or elements made of another functionally equivalent material, wherein said elements are connected to the room elements. These materials on the one hand are suitable for achieving a sufficient acoustic decoupling of the room element (stairhouse) and on the other hand allow relative movements in the Z-direction. If they are constructively designed and/or arranged accordingly, such insulators are suitable for compensating shearing forces that occur in the X- or Y-direction.

According to another advantageous exemplary embodiment of the present invention that is defined in claim 4, the locking element is formed by a laminated fabric block. The laminated fabric block assigned to one room element comprises a vertically inserted guide pin that is preferably made of metal, wherein said guide pin engages into a receptacle of the other corresponding room element and cooperates with a spring. Alternatively, it would be possible to provide a metal tube, in which a first spring is inserted into the tube and a second spring encloses the tube on its outer side. Sections of the springs that protrude relative to the tube are directly or indirectly supported on the other room element. The guide pin or the metal tube is preferably enclosed by a bushing that simultaneously guides the outer spring.

According to another advantageous exemplary embodiment of the present invention that is defined in claim 5, the locking element includes a disk-like insulator in the form of a rubber or plastic element that features correspondingly positioned guide pins on both sides. To this end, it is preferred to provide corrosion-protected steel pins such as, for example, galvanized steel pins, the corresponding end disk of which is integrally connected to the insulator, for example, by means of a vulcanization.

According to another advantageous exemplary embodiment of the present invention that is defined in claim 6, the locking element comprises an insulator in the form of a cylindrically shaped block made of rubber or plastic. A radially stepped holder that is mounted on one room element and centers the insulator is pressed into the insulator on one side in a form-fitted fashion. On the opposite side, the insulator is mounted by means of a guide pin that is integrally connected to the connecting piece together with a disk.

According to another exemplary embodiment of the present invention that is defined in claim 7, each room element features two holders that are spaced apart from one another in order to form the locking elements. Accordingly, each holder features a limb that is bent at a right angle on its end, wherein said limbs are aligned toward one another on the first room element and opposite to one another on the second room element. In the installed position, the limbs that overlap to a limited degree are elastically connected by means of insulators realized in the form of a disk.

According to another exemplary embodiment of the present invention that is defined in claim 8, the locking element features an insulator with the geometric shape of a ring that is arranged upright. The ring can be advantageously dimensioned such that it is relatively soft in the Z-direction in order to carry out an unhindered relative movement and to simultaneously achieve an optimal acoustic decoupling. Two opposing pins realized in the form of screws are preferably assigned to the insulator for mounting purposes, wherein the disk-shaped screw heads of said screws are supported on an inner contour of the ring element and tightened by means of a screw nut arranged on the outer wall of the insulator on the opposite side. In order to achieve a permanent mounting, the screw connections are corrosion-treated such as, for example, cadmium-plated, phosphorized or galvanized.

According to another advantageous exemplary embodiment of the present invention that is defined in claim 10, the locking element features a bracket, in which an insulator in the form of a rubber or plastic element is held in a form-fitted fashion. The end of a holding pin or connecting piece inserted into the insulator features a top disk that extends radially and covers an opening region of the bracket. The design and the arrangement of this locking element are preferably suitable for realizing a relative movement between the room elements in the Z-direction.

According to another advantageous exemplary embodiment of the present invention that is defined in claim 11, the locking element features a bracket that is mounted on the first room element and comprises an elastic annular bead as insulator. This insulator is enclosed by a pot-like receptacle assigned to the second room element. In order to ensure a reliable mounting, the insulator is integrally connected to the components bracket and receptacle, for example, bonded or vulcanized thereto.

According to another exemplary embodiment of the present invention that is defined in claim 12, the locking element comprises a housing that is preferably made of steel and assigned to the first room element. The metal pin positioned in the other room element is guided through a bottom opening in the housing. The locking element causes an acoustic decoupling and allows a relative movement in the Z-direction by means of a spring that connects the end of the metal pin and the housing bottom.

According to another advantageous exemplary embodiment of the present invention that is defined in claim 13, a lining or casing is provided in order to effectively cover the locking elements. Due to the casing of the locking elements that is preferably realized in the form of a ceiling lining, in particular, a relative movement between the room elements in the Z-direction is not visible.

### BRIEF DESCRIPTION OF THE FIGURES

Advantageous exemplary embodiments of the present invention are described below with reference to the enclosed figures.

FIG. 1 shows a fuselage of an aircraft in the form of a side view that elucidates the position of the room elements (overhead compartment, stairhouse).

FIG. 2 shows a section through FIG. 1 along the line A-A′.

FIG. 3 shows a schematic representation of the room elements (crew-rest compartment, stairhouse) including the elastic locking elements and joints.

FIG. 4 shows a first exemplary embodiment of a locking element that includes a support in the form of a laminated fabric block.

FIG. 5 shows a top view of the laminated fabric block of FIG. 4.

FIG. 6 shows a disk-like locking element that is fixed by means of two oppositely arranged holding pins.

FIG. 7 shows a locking element consisting of an insulator in the form of a cylindrically shaped connecting piece, into which an axially protruding, radially stepped holder is incorporated on one side and a metal disk is incorporated on the opposite side.

FIG. 8 shows a locking element, in which elastic insulators are inserted between pairs of angled limbs of holders that are assigned to different components of the room elements.

FIG. 9 shows a locking element in the form of an insulator that is realized as a ring and arranged upright.

FIG. 10 shows a locking element that includes metal disks with a multilayer design and insulators in the form of a round rubber rings.

FIG. 11 shows a locking element in the form of an insulator that is incorporated into a holder and serves for accommodating a holding pin.

FIG. 12 shows a locking element, in which an insulator in the form of an elastic annular bead is inserted between a bracket and a pot-like receptacle.

FIG. 13 shows a locking element that consists of a metal housing with an integrated spring, one end of which is fixed on the bottom of the housing and the other end of which is fixed on a free end of a holding pin guided in the housing.

### DETAILED DESCRIPTION OF THE DRAWINGS

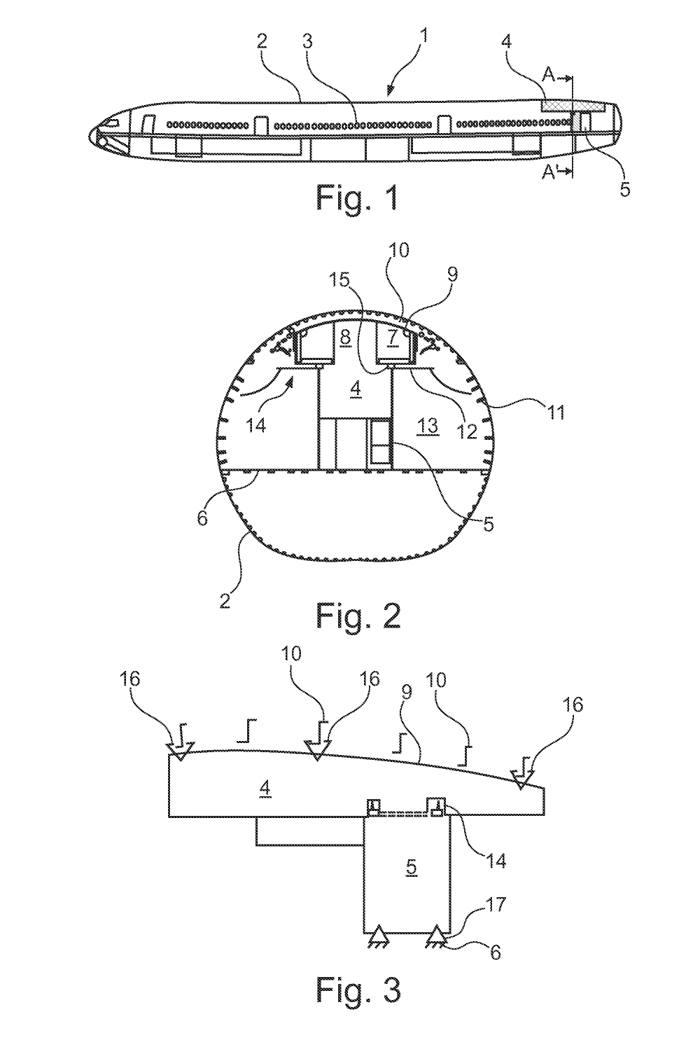

In the following description of FIGS. 1 to 13, identical or corresponding components and elements are at least in part identified by the same reference symbols. Furthermore, the unified term room element is used for the resting and sleeping zone for the service or operating personnel (overhead compartment, crew rest and crew rest compartment) and for the stair assembly (stairhouse).

FIG. 1 shows a side view of a fuselage 2 of an aircraft 1, in the tail section of which a resting and sleeping zone (overhead compartment, crew rest and crew rest compartment) referred to as a room element 4 is provided above a seating area for passengers that is indicated by a row of windows 3, wherein said resting and sleeping zone can be reached via a stair assembly (stairhouse) that is also referred to as a room element 5.

FIG. 2 shows a section through the fuselage 2 along the line of section A-A′ in FIG. 1. The room element 5 or the stair assembly connects a floor structure 6 that is also referred to as cabin floor to the room element 4 or the resting and sleeping zone that features oppositely arranged bunks 7 (bunks) in an upper area 8. On the fuselage side, the room element 4 is enclosed by a chord-like outer surface 9 that is fixed on frames 10 and/or stringers 11 of the fuselage 2 by means of joints 16 illustrated in FIG. 3. The stair assembly or the room element 5 is connected to the room element 4 in an acoustically decoupled fashion by means of elastic locking elements 14 in the region of the ceiling 12 of a passenger compartment 13. In this case, a lining 15 covers the locking elements 14 and prevents a visible relative movement between the room elements 4 and 5.

FIG. 3 shows a schematic representation of the room elements 4, 5. In the region of its outer surface 9, the room element 4 is mounted to the inner side of the fuselage 2 on circumferential frames 16 by means of joints 16 in a largely rigid fashion, however, such that it is insulated from structure-borne sound. The room element 5 is connected to the floor structure 6 by means of joints 17. The joints 16, 17 fix the room elements 4, 5 in the X-, Y- and Z-directions. The locking elements 14 that cause an acoustic decoupling simultaneously allow a relative movement between the room elements 4, 5 in the Z-direction.

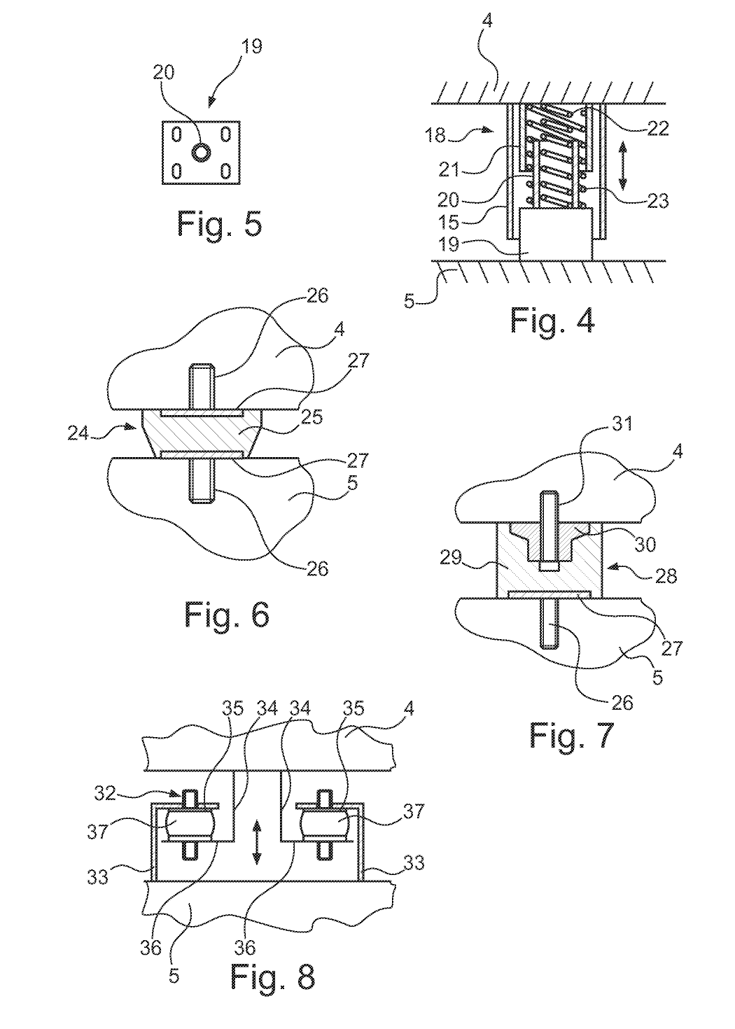

FIG. 4 shows the design of the locking element 18 in the form of a sectional representation. In this case, it is preferred to provide a support 19 in the form of a laminated fabric block that is a sectionally enclosed by a bushing 21 at a radial distance and in which a metal tube 20 is vertically positioned. Two springs 22, 23 are inserted between the support 19 and the room element 4, wherein the spring 22 is guided in the metal tube 20 and the spring 23 encloses the metal tube 20 on its outer side. A visible relative movement of the locking element 18 indicated by the double arrow is prevented by a lining 15 that is fixed on the room element 4 and encloses the locking element 18 on its outer side.

FIG. 5 shows a view of the support 19 in the form of a laminated fabric block, in which the metal tube 20 is positioned centrally. The mounting of the support 19 is realized with screws that are inserted into four oblong holes.

FIG. 6 shows the design of the locking element 24 comprising a disk-like insulator 25 for acoustic decoupling purposes, wherein said insulator can be elastically deformed if compressive stresses occur between the room elements 4, 5. In order to fix the insulator 25, it is preferred to provide guide pins 26 in the form of threaded bolts that are integrally connected, e.g., vulcanized, to the insulator 25 by means of a metal disk 27.

FIG. 7 shows a sectional representation of the locking element 28 comprising an elastic rubber block 29 that is fixed on the room element 5 in a manner comparable to that shown in FIG. 6, namely by means of a guide pin 26 in connection with a metal disk 27. On the opposite side, a radially stepped, axially protruding holder 30 fixed by means of a guide pin 31 is incorporated into the block 29.

FIG. 8 shows the design of the locking element 32 comprising two holders 33 that are assigned to the room element 5 and spaced apart from one another, wherein said holders are designed for accommodating holders 34 of the room element 4. The holders 33, 34 are arranged relative to one another in pairs and respectively form angles 35, 36 that extend perpendicular to one another and are connected by means of insulators 37 arranged parallel to one another.

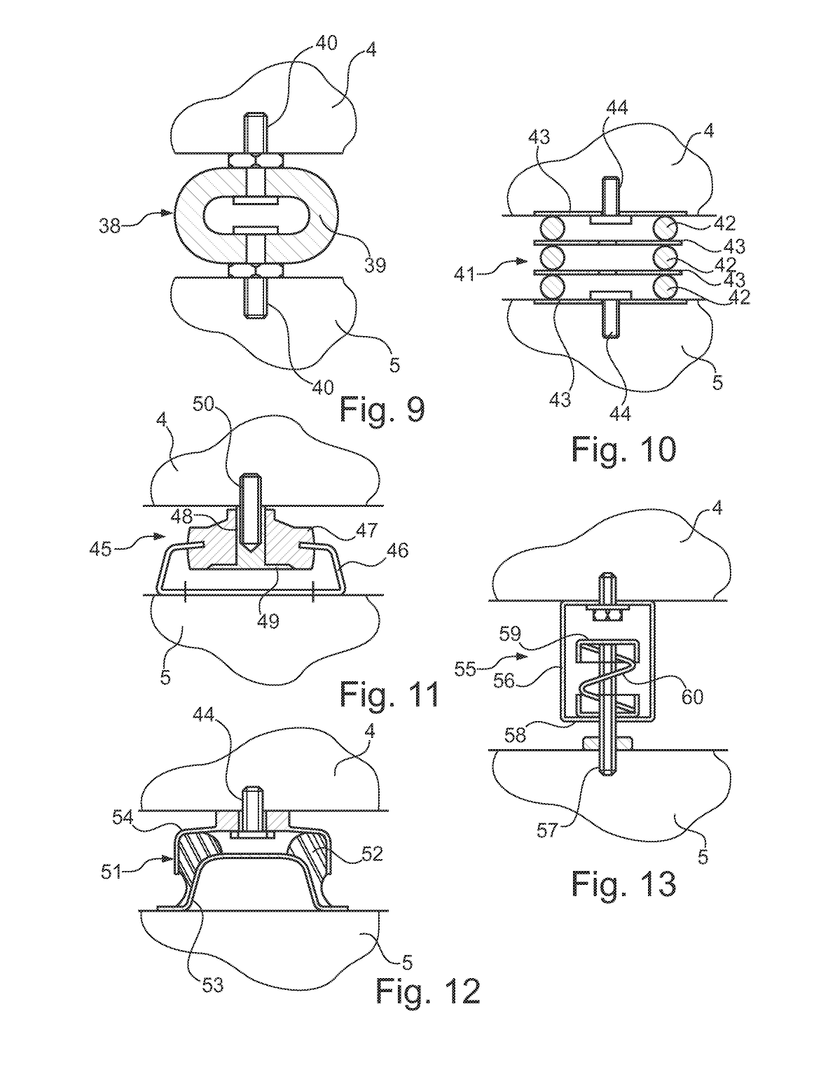

FIG. 9 shows the locking element 38 comprising an annular insulator 39 that is arranged upright. The insulator 39 is connected to the room element 4, 5 for acoustic decoupling purposes by means of two screw connections 40.

FIG. 10 shows the locking element 41 comprising three annular insulators 42 that are arranged in a layered fashion and positioned between the metal disks 43. The lower and the upper metal disk 43 are connected to the room elements 4, 5 by means of screw connections 44.

FIG. 11 shows the locking element 45 featuring a bracket 46 that is separably mounted to the room element 5 and serves for accommodating an insulator 47. A connecting piece 48 incorporated into the insulator 47 covers a front side of the insulator 47 by means of a disk 49 that has a large surface on the bracket side. On the distant side referred to the disk, the connecting piece 48 forms a receptacle for a threaded bolt 50 screwed into the room element 4.

FIG. 12 shows the locking element 51 featuring an insulator 52 that forms an elastic annular wall and encloses a support 53 in the form of a reinforcement. The insulator 52 is inserted into a pot-like receptacle 54 that is also made of metal. In order to produce an integral connection, the insulator 52 is, for example, vulcanized to the support 53 and the receptacle 54. The locking element 51 is connected to the room elements 4, 5 by means of a screw connection 44, as well as mounting means that are not illustrated in detail.

FIG. 13 shows the locking element 53 comprising a housing that is screwed to the room element 4 and into which a metal pin 57 assigned to the room element 5 engages. A spring 60 arranged between the bottom 58 of the housing 56 and an end 59 of the metal pin effectively decouples relative movements between the room elements 4, 5 acoustically.

As an alternative to the description of FIGS. 4, 7, 8, 11, 12 and 13, the acoustic decoupling can also be achieved with a reversed installation position of the locking elements 18, 28, 32, 45, 51, 55.

As a supplement, it should be noted that “comprising” does not exclude other elements or steps, and that “an” or “a” does not exclude a plurality. It should furthermore be noted that characteristics or steps that were described with reference to one of the above exemplary embodiments can also be used in combination with other characteristics or steps of other above-described exemplary embodiments.

### LIST OF REFERENCE SYMBOLS

1 Aircraft
2 Fuselage
3 Row of windows
4 Room element
5 Room element
6 Floor structure
7 Bunk
8 Area
9 Outer surface
10 Frames
11 Stringers
12 Ceiling
13 Passenger compartment
14 Locking element
15 Lining
16 Joint
17 Joint
18 Locking element
19 Support
20 Metal tube
21 Bushing
22 Spring
23 Spring
24 Locking element
25 Insulator
26 Guide pin
27 Metal disk
28 Locking element
29 Block
30 Holder
31 Guide pin
32 Locking element
33 Holder
34 Holder
35 Limb
36 Limb
37 Insulator
38 Locking element
39 Insulator
40 Screw connection
41 Locking element
42 Insulator
43 Metal disk
44 Screw connection
45 Locking element
46 Bracket
47 Insulator
48 Connecting piece
49 Disk
50 Threaded bolt
51 Locking element
52 Insulator
53 Support
54 Receptacle
55 Locking element
56 Housing
57 Metal pin
58 Bottom
59 End of metal pin
60 Spring

1. An aircraft comprising:
a fuselage including:
an overhead compartment having at least one resting and sleeping zone for service or operations personnel, which is referred to as a first room element and which is arranged to be reached from a floor structure of an aircraft cabin via a second room element referred to as a stair assembly;
wherein the first room element is arranged a distance above a seating area for the passengers;
wherein the second room element is acoustically decoupled from the first room element by elastic locking elements; and
wherein the individual first and second room elements are directly or indirectly fixed to the fuselage or the floor structure of the aircraft by joints.

2. The aircraft of claim 1, wherein the elastic locking elements allow relative movements of the first and second room elements in the Z-direction and largely prevents relative movement in the X- and Y-directions.

3. The aircraft of claim 1, wherein the elastic locking elements incorporate an absorber body that absorbs relative movements and vibrations, the absorber body including an absorbing element selected from the group consisting of a rubber element made of caoutchouc or natural rubber, a plastic element, and a spring element,
wherein said absorbing elements is connected to the first and second room elements.

4. The aircraft of claim 1, wherein the elastic locking elements each comprise a laminated fabric block that is assigned to the second room element and includes a vertically inserted metal tube or guide pin that engages into a receptacle of the first room element and cooperates with a spring enclosed by a bushing.

5. The aircraft of claim 1, wherein the elastic locking elements each comprise a disk-like insulator in the form of a rubber or plastic element, to which correspondingly positioned guide pins are assigned on both sides, wherein said guide pins respectively being integrally connected to the disk-like insulator by a corresponding metal disk and fitted into receptacle bores of the first and second room elements.

6. The aircraft of claim 1, wherein the elastic locking elements each comprise an axially protruding, radially stepped holder that is fitted into a cylindrically shaped block as an insulator in a form-fitted fashion; and
wherein the cylindrically shaped block is fixed to the first and second room elements by guide pins.

7. The aircraft of claim 1, wherein each of the first and second room elements comprises two holders that are spaced apart from one another in order to form at least one of the elastic locking elements, wherein said holders are bent at a right angle on ends thereof and form two limbs that are directed toward one another or away from one another in pairs; and
wherein the two limbs of both room elements that in pairs overlap to a limited degree are elastically connected by at least one insulator in the form of a disk.

8. The aircraft of claim 1, wherein the elastic locking elements each comprise an insulator in the form of a ring and is inserted upright, wherein at least one of the elastic locking elements is fixed by opposite screw connections.

9. The aircraft of claim 1, wherein metal disks and insulators in the form of round rubber rings are alternately combined into a multilayer damping assembly in order to form at least one of the elastic locking elements, wherein metal disks arranged on the ends are mounted to the first and second room elements by screw connections.

10. The aircraft of claim 1, wherein at least one of the elastic locking elements includes a bracket;
wherein an insulator is held in a form-fitted fashion, with said insulator accommodating a connecting piece with a disk that has a large surface and is supported on the insulator such that the disk covers an opening of the bracket.

11. The aircraft of claim 1, wherein at least one of the elastic locking elements comprises a support having an insulator in the form of an annular bead, the insulator being enclosed by a pot-like receptacle.

12. The aircraft of claim 1, wherein at least one of the elastic locking elements includes a housing that is assigned to the first room element and into which a metal pin of the second room element engages, wherein a spring is integrated into the housing and connects an end of the metal pin to a housing bottom.

13. The aircraft of claim 1, wherein a lining is assigned to at least one of the first and second room elements in order to cover the elastic locking elements.
